(19) United States
(12) Patent Application Publication
(10) Pub. No.: US 2026/0353511 A1
(43) Pub. Date: Nov. 5, 2026

(54) METHOD AND APPARATUS FOR PERFORMING COMMUNICATION IN WIRELESS COMMUNICATION SYSTEM

(71) Applicant: Samsung Electronics Co., Ltd., Suwon-si, Gyeonggi-do (KR)

(72) Inventors: Sangkyu BAEK, Suwon-si (KR); Anil AGIWAL, Suwon-si (KR)

(21) Appl. No.: 19/099,265

(22) PCT Filed: Aug. 4, 2023
(86) PCT No.: PCT/KR2023/011508

§ 371 Date: Jan. 28, 2025

(30) Foreign Application Priority Data
Aug. 5, 2022 (KR) 10-2022-0098001

(51) Int. Cl. H04W 76/40; H04W 48/20; H04W 76/30

(52) U.S. Cl. CPC H04W 76/40; H04W 48/20; H04W 76/30

(57) ABSTRACT

The disclosure relates to a 5G or 6G communication system for supporting a higher data transmission rate. A method performed by a user equipment (UE) in wireless communication system is provided. The method comprises performing multicast reception in a radio resource control (RRC) inactive state on a first cell; in case that cell selection criteria is met, performing cell selection to a second cell; identifying whether the second cell supports the multicast reception in the RRC inactive state; and continuing the multicast reception in the RRC inactive state on the second cell, based on the second cell supporting the multicast reception in the RRC inactive state.

### TECHNICAL FIELD

The disclosure relates to wireless communication systems, and more particularly, to a method and an apparatus for handling mobility for multicast reception in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

The disclosure relates a method and an apparatus for handling mobility for multicast reception in a wireless communication system.

According to an aspect of the disclosure, a method performed by a user equipment (UE) in a wireless communication system is provided. The method may include performing multicast reception in a radio resource control (RRC) inactive state on a first cell. The method may include, in case that cell selection criteria is met, performing cell selection to a second cell. The method may include identifying whether the second cell supports the multicast reception in the RRC inactive state. The method may include continuing the multicast reception in the RRC inactive state on the second cell, based on the second cell supporting the multicast reception in the RRC inactive state.

According to an aspect of the disclosure, a user equipment (UE) in a wireless communication system is provided. The UE may comprise a transceiver and at least one processor coupled with the transceiver. The at least one processor may be configured to perform multicast reception in a radio resource control (RRC) inactive state on a first cell. The at least one processor may be configured to perform cell selection to a second cell in case that cell selection criteria is met. The at least one processor may be configured to identify whether the second cell supports the multicast reception in the RRC inactive state. The at least one processor may be configured to continue the multicast reception in the RRC inactive state on the second cell, based on the second cell supporting the multicast reception in the RRC inactive state.

### BRIEF DESCRIPTION OF DRAWINGS

FIG. 1 illustrates a flow chart describing UE operation according to an embodiment of the disclosure.

FIG. 2 illustrates a flow chart describing UE operation according to an embodiment of the disclosure.

FIG. 3 illustrates a flow chart describing UE operation according to an embodiment of the disclosure.

FIG. 4 illustrates a flow chart describing UE operation according to an embodiment of the disclosure.

FIG. 5 illustrates a flow chart describing UE operation according to an embodiment of the disclosure.

FIG. 6 illustrates a flow chart describing UE operation according to an embodiment of the disclosure.

FIG. 7 illustrates a flow chart describing UE operation according to an embodiment of the disclosure.

FIG. 8 illustrates a structure of a UE, according to an embodiment of the disclosure.

FIG. 9 illustrates a structure of a BS, according to an embodiment of the disclosure.

FIG. 10 illustrates a method performed by UE, according to an embodiment of the disclosure.

### MODE FOR THE INVENTION

Throughout the disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units”, or may be divided into additional elements and “units”. Furthermore, the elements and “units” may be embodied to reproduce one or more central processing units (CPUs) in a device or security multimedia card. Also, in an embodiment of the disclosure, the “unit” may include at least one processor. In the following descriptions of the disclosure, well-known functions or configurations are not described in detail because they would obscure the disclosure with unnecessary details.

Hereinafter, for convenience of explanation, the disclosure uses terms and names defined in the 3rd generation partnership project long term evolution (3GPP LTE) standards. However, the disclosure is not limited to the terms and names, and may also be applied to systems following other standards.

In the disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a user equipment (UE), a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IoT devices, sensors, and other wireless communication devices.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam. PDCP may refer to Packet Data Convergence Protocol, SDAP may refer to Service Data Adaptation Protocol.

The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC there is only one serving cell comprising the primary cell. For a UE in RRC_CONNECTED configured with CA/DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

In the fifth generation wireless communication system, node B (gNB) or base station in cell broadcast Synchronization Signal and PBCH block (SSB) consists of primary and secondary synchronization signals (PSS, SSS) and system information. System information includes common parameters needed to communicate in cell. In the fifth generation wireless communication system (also referred as next generation radio or NR), System Information (SI) is divided into the MIB and a number of SIBs where:
the MIB is always transmitted on the BCH with a periodicity of 80 ms and repetitions made within 80 ms and it includes parameters that are needed to acquire SIB1 from the cell.
the SIB1 is transmitted on the DL-SCH with a periodicity of 160 ms and variable transmission repetition. The default transmission repetition periodicity of SIB1 is 20 ms but the actual transmission repetition periodicity is up to network implementation. The scheduling information in SIB 1 includes mapping between SIBs and SI messages, periodicity of each SI message and SI window length. The scheduling information in SIB 1 includes an indicator for each SI message, which indicates whether the concerned SI message is being broadcasted or not. If at least one SI message is not being broadcasted, SIB1 may include random access resources (PRACH preamble(s) and PRACH resource(s)) for requesting gNB to broadcast one or more SI message(s).
SIBs other than SIB1 are carried in SystemInformation (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID.

In the fifth generation wireless communication system, Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations are signaled by GNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’satisfies the equation below:

(y*(number of slots in a radio frame)+x−Monitoring-offset-PDCCH-slot) mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations are signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is QCLed with SSB/CSI RS of TCI state) used by GNB for transmission of PDCCH in the PDCCH monitoring occasions of a search space.

In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-Inactivity Timer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveU-plinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state.

In the 5th generation (also referred as NR or New Radio) wireless communication system UE can be in one of the following RRC state: RRC IDLE, RRC INACTIVE and RRC CONNECTED. The RRC states can further be characterized as follows:
In RRC_IDLE state, a UE specific DRX may be configured by upper layers (i.e. NAS). The UE, monitors Short Messages transmitted with paging radio network temporary identifier (P-RNTI) over DCI; Monitors a Paging channel for CN paging using 5G-S-TMSI;-Performs neighbouring cell measurements and cell (re-)selection; Acquires system information and can send SI request (if configured).
In RRC_INACTIVE state, a UE specific DRX may be configured by upper layers or by RRC layer; In this state, UE stores the UE Inactive AS context. A radio access network (RAN)-based notification area is configured by RRC layer. The UE monitors Short Messages transmitted with P-RNTI over DCI; Monitors a Paging channel for CN paging using 5G-S-TMSI and RAN paging using fullI-RNTI; Performs neighbouring cell measurements and cell (re-)selection; Performs RAN-based notification area updates periodically and when moving outside the configured RAN-based notification area; Acquires system information and can send SI request (if configured).
In the RRC_CONNECTED, the UE stores the AS context. Unicast data is transmitted/received to/from UE. At lower layers, the UE may be configured with a UE specific DRX. The UE, monitors Short Messages transmitted with P-RNTI over DCI, if configured; Monitors control channels associated with the shared data channel to determine if data is scheduled for it; Provides channel quality and feedback information; Performs neighbouring cell measurements and measurement reporting; Acquires system information.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the AMF (Access and Mobility Management Function) by means of the NG-C interface and to the UPF (User Plane Function) by means of the NG-U interface. In the 5th generation (also referred as NR or New Radio) wireless communication system, the UE may use Discontinuous Reception (DRX) in RRC_IDLE and RRC_INACTIVE state in order to reduce power consumption. In the RRC_IDLE/RRC_INACTIVE state UE wake ups at regular intervals (i.e. every DRX cycle) for short periods to receive paging, to receive SI update notification and to receive emergency notifications. Paging message is transmitted using physical downlink shared channel (PDSCH). Physical downlink common control channel (PDCCH) is addressed to P-RNTI if there is a paging message in PDSCH. P-RNTI is common for all UEs. UE identity (i.e. S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e. PDCCH is masked with P-RNTI) over data channel (i.e. PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. In RRC connected state, UE can monitor any PO in paging DRX cycle and monitors at least one PO in SI modification period. In the RRC idle/inactive mode UE monitors PO every DRX cycle in its active DL BWP. A PO is a set of ‘S’ PDCCH monitoring occasions for paging, where ‘S’ is the number of transmitted SSBs (i.e. the Synchronization Signal and PBCH block (SSB) consists of primary and secondary synchronization signals (PSS, SSS) and PBCH) in cell. UE first determines the paging frame (PF) and then determines the PO with respect to the determined PF. One PF is a radio frame (10 ms).

Multicast reception in fifth generation wireless communication system: A multicast communication service is delivered to the UEs using a multicast session. A UE can receive a multicast communication service in RRC_CONNECTED state with mechanisms such as PTP and/or PTM delivery. HARQ feedback/retransmission can be applied to both PTP and PTM transmission. For a multicast session, gNB provides multicast multicast/broadcast Service (MBS) radio bearer (MRB) configuration(s) to the UE via dedicated RRC signalling: If the UE which joined a multicast session is in RRC_CONNECTED state and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's radio link control (RLC) entities.

When there is (temporarily) no data to be sent to the UEs for a multicast session, the gNB may move the UE to RRC IDLE/INACTIVE state. gNBs supporting MBS use a group notification mechanism to notify the UEs in RRC IDLE/INACTIVE state when a multicast session has been activated by the CN or the gNB has multicast session data to deliver. Upon reception of the group notification, the UEs reconnect to the network i.e. it initiated connection setup/resumption and enters RRC_CONNECTED. The group notification is addressed with P-RNTI on PDCCH.

To minimize connection setup/resumption by UEs in RRC_INACTIVE state, multicast reception (may also be referred as MBS multicast reception) by UEs in RRC_INACTIVE state can be considered in fifth generation wireless communication system. Network may provide multicast reception configuration for RRC_INACTIVE in RRC_Release/RRC Reconfiguration message. UE enters RRC_INACTIVE and starts multicast reception based on the configuration. Due to mobility, cell reselection occurs while UE is receiving multicast reception in RRC_INACTIVE. In this scenario method to handle ongoing multicast reception is needed.

### Method 1

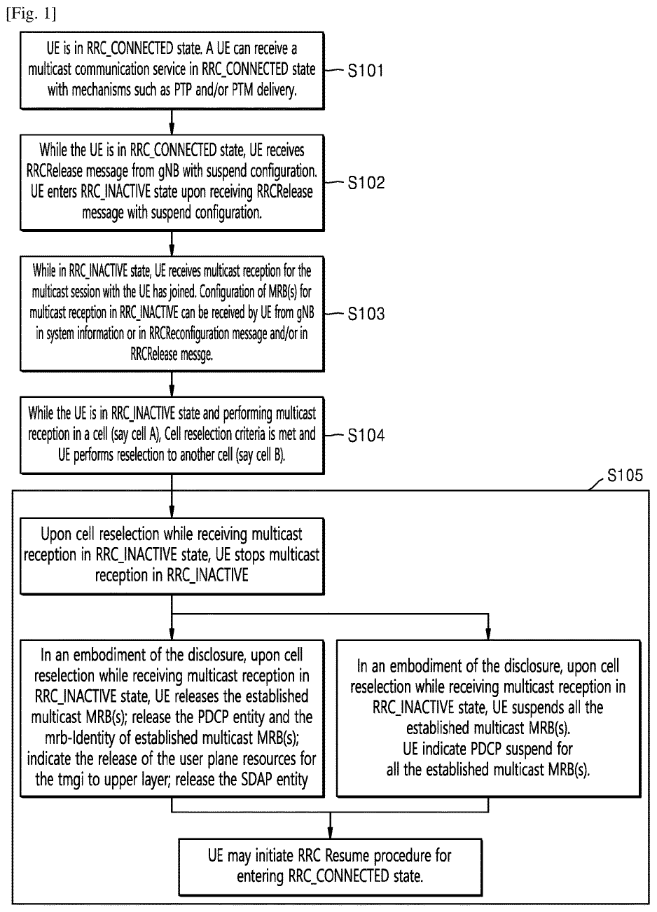

53 FIG. 1 illustrates a flow chart describing UE operation according to an embodiment of the disclosure.

In operation S101: UE is in RRC_CONNECTED state. A UE can receive a multicast communication service in RRC_CONNECTED state with mechanisms such as point to point (PTP) and/or point to multipoint (PTM) delivery. For a multicast session, gNB provides multicast MRB configuration(s) to the UE via dedicated RRC signalling (e.g. RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

In operation S102: While the UE is in RRC_CONNECTED state, the UE receives RRCRelease message from the gNB with suspend configuration. The UE enters RRC_INACTIVE state upon receiving RRCRelease message with suspend configuration.

In operation S103: While in RRC_INACTIVE state, the UE receives multicast reception for the multicast session which the UE has joined. Configuration of MRB(s) for multicast reception in RRC_INACTIVE can be received by UE from gNB in system information or in RRCReconfiguration message and/or in RRCRelease message. If a multicast session is active at the time of entering RRC_INACTIVE state, the UE continues multicast reception of that multicast session; and the UE need not suspend the MRB (or MRB with PTM) corresponding to active multicast session at the time of entering RRC_INACTIVE state. If a multicast session is not active at the time of entering RRC_INACTIVE state, the UE suspends the MRB corresponding to the multicast session when entering RRC_INACTIVE state. The UE resumes the MRB(s) and starts multicast reception in RRC_INACTIVE when session activation notification in paging message is received by the UE for that multicast session(s) (i.e. temporary mobile group identity (TMGI) (s) is included in paging message for one or more multicast sessions activated). In an embodiment of this disclosure, if the UE receives paging message:
1> if in RRC_INACTIVE and the UE has joined one or more MBS session(s) indicated by the TMGI included in the pagingGroupList;
2> if multicast reception is supported in RRC_INACTIVE state (or if the UE has configuration for multicast reception in RRC_INACTIVE and/or if gNB has indicated that it supports multicast reception in RRC_INACTIVE in system information or RRC signalling (RRC Release or RRCReconfiguration):
3> UE initiate procedure to receive multicast reception in RRC_INACTIVE (e.g.

resume one or more MRB(s), establish/re-establish PDCP/RLC entity for the resumed MRBs, etc.)
2>else if none of the ue-Identity included in any of the PagingRecord, if included in the Paging message, matches the UE identity allocated by upper layers
3>initiate the RRC connection resumption procedure with resumeCause set as below:
4> if the UE is configured by upper layers with Access Identity 1:
5> resumeCause is set to mps-PriorityAccess;
4> else if the UE is configured by upper layers with Access Identity 2:
5> resumeCause is set to mcs-PriorityAccess;
4> else if the UE is configured by upper layers with one or more Access Identities equal to 11-15:
5> resumeCause is set to highPriorityAccess;
4> else:
5> resumeCause is set to mt-Access.

In operation S104: While the UE is in RRC_INACTIVE state and performing multicast reception in a cell (say cell A), Cell reselection criteria is met and the UE performs reselection to another cell (say cell B).

In operation 105: Upon cell reselection while receiving multicast reception in RRC_INACTIVE state, the UE performs the following operation:> The UE may stop multicast reception in RRC_INACTIVE.
> In an embodiment of the disclosure, the UE releases the established multicast MRB(s); the UE releases the PDCP entity and the mrb-Identity of established multicast MRB(s); the UE indicates the release of the user plane resources for the tmgi to upper layers; the UE releases the SDAP entity.
> In an embodiment of the disclosure, the UE suspends all the established multicast MRB(s). The UE indicates PDCP suspend for all the established multicast MRB(s).
> The UE may initiate RRC Resume procedure for entering RRC_CONNECTED state.

### Method 2

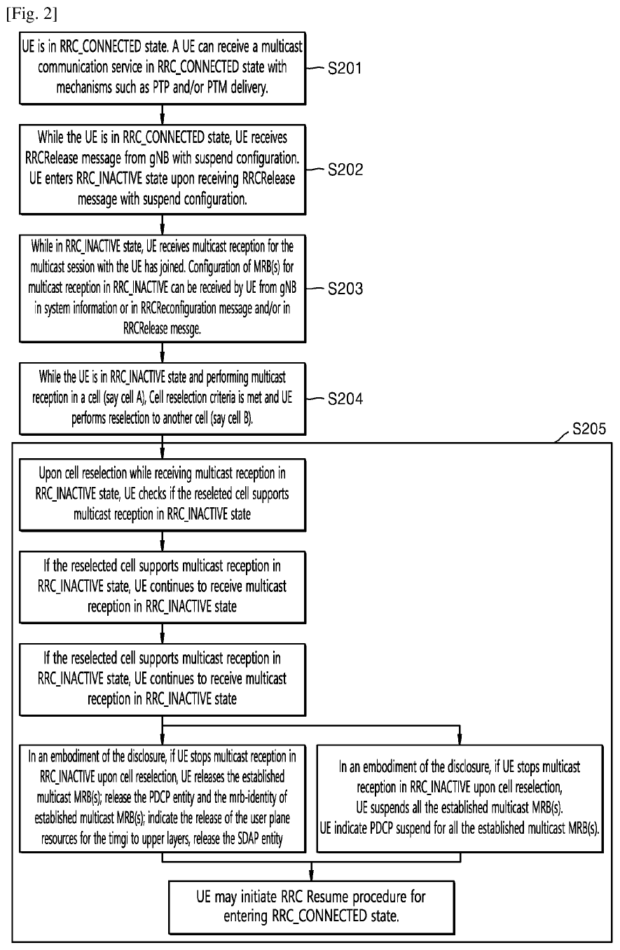

FIG. 2 illustrates a flow chart describing UE operation according to an embodiment of the disclosure.

In operation S201: A UE is in RRC_CONNECTED state. The UE can receive a multicast communication service in RRC_CONNECTED state with mechanisms such as PTP and/or PTM delivery. For a multicast session, a gNB provides multicast MRB configuration(s) to the UE via dedicated RRC signalling (e.g. RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

In operation S202: While the UE is in RRC_CONNECTED state, the UE receives RRCRelease message from the gNB with suspend configuration. The UE enters RRC_INACTIVE state upon receiving RRCRelease message with suspend configuration.

In operation S203: While in RRC_INACTIVE state, the UE receives multicast reception for the multicast session which the UE has joined. Configuration of MRB(s) for multicast reception in RRC_INACTIVE can be received by UE from gNB in system information or in RRCReconfiguration message and/or in RRCRelease message. If a multicast session is active at the time of entering RRC_INACTIVE state, the UE continues multicast reception of that multicast session; and the UE need not suspend the MRB (or MRB with PTM) corresponding to active multicast session at the time of entering RRC_INACTIVE state. If a multicast session is not active at the time of entering RRC_INACTIVE state, the UE suspends the MRB corresponding to the multicast session when entering RRC_INACTIVE state. The UE resumes the MRB(s) and starts multicast reception in RRC_INACTIVE when session activation notification in paging message is received by the UE for that multicast session(s) (i.e. TMGI(s) is included in paging message for multicast sessions activated). In an embodiment of this disclosure, if the UE receives paging message:
1> if in RRC_INACTIVE and the UE has joined one or more MBS session(s) indicated by the TMGI included in the pagingGroupList; and
2> if multicast reception is supported in RRC_INACTIVE state (or if the UE has configuration for multicast reception in RRC_INACTIVE and/or if gNB has indicated that it supports multicast reception in RRC_INACTIVE in system information or RRC signalling (RRC Release or RRCReconfiguration):
4> UE initiate procedure to receive multicast reception in RRC_INACTIVE (e.g. resume one or more MRB(s), establish/re-establish PDCP/RLC entity for the resumed MRBs, etc.)
1>2> else if none of the ue-Identity included in any of the PagingRecord, if included in the Paging message, matches the UE identity allocated by upper layers:
3> initiate the RRC connection resumption procedure with resumeCause set as below:
4> if the UE is configured by upper layers with Access Identity 1:
5> resumeCause is set to mps-PriorityAccess;
4> else if the UE is configured by upper layers with Access Identity 2:
5> resumeCause is set to mcs-PriorityAccess;
4> else if the UE is configured by upper layers with one or more Access Identities equal to 11-15:
5> resumeCause is set to highPriorityAccess;
4> else:
5> resumeCause is set to mt-Access.

Configuration of MRB(s) for multicast reception in RRC_INACTIVE can be received by the UE from the gNB in system information or in RRCReconfiguration message and/or in RRCRelease message.

In operation S204: While the UE is in RRC_INACTIVE state and performing multicast reception in a cell (say cell A), Cell reselection criteria is met and the UE performs reselection to another cell (say cell B).

In operation S205: Upon cell reselection while receiving multicast reception in RRC_INACTIVE state, the UE performs the following operation:
> The UE checks if the reselected cell supports multicast reception in RRC_INACTIVE state.
>> Indication whether cell support or not support multicast reception in RRC INACTIVE state can be included in system information transmitted by the reselected cell or by another cell (e.g. cell UE is camped on) before reselection. If the reselected cell does not provide configuration for multicast reception of multicast sessions joined by UE in RRC_INACTIVE, UE can consider that the cell does not support multicast reception in RRC_INACTIVE.
> If the reselected cell supports multicast reception in RRC_INACTIVE state:
>> The UE continues to receive multicast reception in RRC_INACTIVE state. If the MRB(s) configuration for multicast reception in RRC_INACTIVE is different in reselected cell, the UE applies the configuration of the reselected cell (in system information or in RRCReconfiguration message and/or in RRCRelease message)
> Else If the reselected cell does not support multicast reception in RRC_INACTIVE state:
>> The UE stops multicast reception in RRC_INACTIVE.
>> In an embodiment of the disclosure, the UE releases the established multicast MRB(s); the UE releases the PDCP entity and the mrb-Identity of established multicast MRB(s); the UE indicates the release of the user plane resources for the tmgi to upper layers; the UE releases the SDAP entity
>> In an embodiment of the disclosure, the UE suspends all the established multicast MRB(s). The UE indicate PDCP suspend for all the established multicast MRB(s).
>> The UE may initiate RRC Resume procedure for entering RRC_CONNECTED state.

In operation S205 (Alternate): Upon cell reselection while receiving multicast reception in RRC_INACTIVE state, the UE performs the following operation:
> The UE checks if the reselected cell supports multicast reception in RRC_INACTIVE state.
>> Indication whether cell supports multicast reception in RRC_INACTIVE state can be included in system information transmitted by the reselected cell or by another cell (e.g. cell UE is camped on) before reselection. If the reselected cell does not provide configuration for multicast reception of multicast sessions joined by UE in RRC_INACTIVE, UE can consider that the cell does not support multicast reception in RRC_INACTIVE.> If the reselected cell supports multicast reception in RRC_INACTIVE state:
>> For the multicast sessions which the UE is currently receiving and supported in reselected cell, the UE continues to receive multicast reception in RRC_INACTIVE state.
>> For the multicast sessions which UE is currently receiving and not supported in reselected cell, the UE stops multicast reception in RRC_INACTIVE.
>> If the MRB(s) configuration for multicast reception in RRC_INACTIVE is different in reselected cell, the UE applies the configuration of the reselected cell (in system information or in RRCReconfiguration message and/or in RRCRelease message).
>Else If the reselected cell does not support multicast reception in RRC_INACTIVE state:
>> The UE stops multicast reception in RRC_INACTIVE.
>> In an embodiment of the disclosure, the UE releases the established multicast MRB(s); the UE releases the PDCP entity and the mrb-Identity of established multicast MRB(s); indicates the release of the user plane resources for the tmgi to upper layers; the UE releases the SDAP entity.
>> In an embodiment of the disclosure, the UE suspends all the established multicast MRB(s). The UE indicate PDCP suspend for all the established multicast MRB(s).
>> The UE may initiate RRC Resume procedure for entering RRC_CONNECTED state.

### Method 3

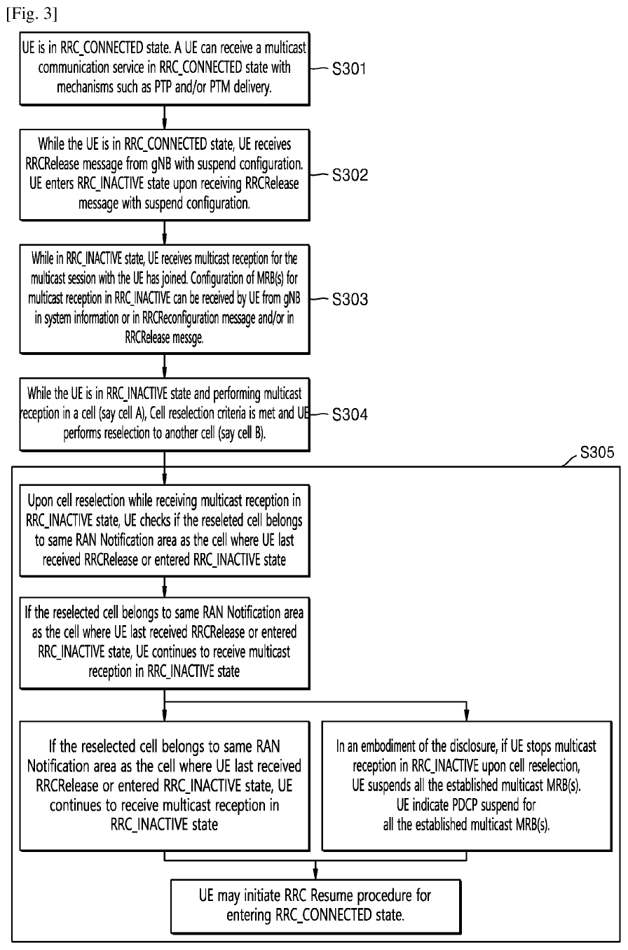

FIG. 3 illustrates a flow chart describing UE operation according to an embodiment of the disclosure.

In operation S301: A UE is in RRC_CONNECTED state. The UE can receive a multicast communication service in RRC_CONNECTED state with mechanisms such as PTP and/or PTM delivery. For a multicast session, a gNB provides multicast MRB configuration(s) to the UE via dedicated RRC signalling (e.g. RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities In operation S302: While the UE is in RRC_CONNECTED state, the UE receives RRCRelease message from the gNB with suspend configuration. The UE enters RRC_INACTIVE state upon receiving RRCRelease message with suspend configuration.

In operation S303: While in RRC_INACTIVE state, the UE receives multicast reception for the multicast session which the UE has joined. If a multicast session is active at the time of entering RRC_INACTIVE state, the UE continues multicast reception of that multicast session; and the UE need not suspend the MRB (or MRB with PTM) corresponding to active multicast session at the time of entering RRC_INACTIVE state. If a multicast session is not active at the time of entering RRC_INACTIVE state, the UE suspends the MRB corresponding to the multicast session when entering RRC_INACTIVE state. The UE resumes the MRB(s) and starts multicast reception in RRC_INACTIVE when session activation notification in paging message is received by the UE for that multicast session(s) (i.e. TMGI(s) is included in paging message for multicast sessions activated). In an embodiment of this disclosure, if the UE receives paging message:
1> if in RRC_INACTIVE and the UE has joined one or more MBS session(s) indicated by the TMGI included in the pagingGroupList; and
2> if multicast reception is supported in RRC_INACTIVE state (or if the UE has configuration for multicast reception in RRC_INACTIVE and/or if gNB has indicated that it supports multicast reception in RRC_INACTIVE in system information or RRC signalling (RRC Release or RRCReconfiguration):
3> the UE initiates procedure to receive multicast reception in RRC_INACTIVE (e.g. resume one or more MRB(s), establish/re-establish PDCP/RLC entity for the resumed MRBs, etc.)
2> else if none of the ue-Identity included in any of the PagingRecord, if included in the Paging message, matches the UE identity allocated by upper layers:
3> initiate the RRC connection resumption procedure with resumeCause set as below:
4> if the UE is configured by upper layers with Access Identity 1:
5> resumeCause is set to mps-PriorityAccess;
4> else if the UE is configured by upper layers with Access Identity 2:
5> resumeCause is set to mcs-PriorityAccess;
4> else if the UE is configured by upper layers with one or more Access Identities equal to 11-15:
5> resumeCause is set to highPriorityAccess;
4> else:
5> resumeCause is set to mt-Access.

Configuration of MRB(s) for multicast reception in RRC_INACTIVE can be received by the UE from the gNB in system information or in RRCReconfiguration message and/or in RRCRelease message.

In operation S304: While the UE is in RRC_INACTIVE state and performing multicast reception in a cell (say cell A), Cell reselection criteria is met and the UE performs reselection to another cell (say cell B).

In operation S305: Upon cell reselection while receiving multicast reception in RRC_INACTIVE state, the UE performs the following operation:
> The UE checks if the reselected cell belongs to same RAN Notification area as the cell where the UE last received RRCRelease or entered RRC_INACTIVE state (RAN Notification area is signaled in system information transmitted by cell or RRC signaling). The UE may additionally check whether the reselected cell supports multicast reception in RRC_INACTIVE state.
> If the reselected cell belongs to same RAN Notification area as the cell where the UE last received RRCRelease or entered RRC_INACTIVE state and if the reselected cell supports multicast reception in RRC_INACTIVE state; or
> If the reselected cell belongs to same RAN Notification area as the cell where the UE last received RRCRelease or entered RRC_INACTIVE state:
>> The UE continues to receive multicast reception in RRC_INACTIVE state. If the MRB(s) configuration for multicast reception in RRC_INACTIVE is different in reselected cell, the UE applies the configuration of the reselected cell (in system information or in RRCReconfiguration message and/or in RRCRelease message).
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the releases of the user plane resources for the tmgi to upper layers; releases the SDAP entity.
>> In an embodiment of the disclosure, the UE suspends all the established multicast MRB(s). The UE indicates PDCP suspend for all the established multicast MRB(s).
>> The UE may initiate RRC Resume procedure for entering RRC_CONNECTED state.

In operation S305 (Alternate): Upon cell reselection while receiving multicast reception in RRC_INACTIVE state, the UE performs the following operation:
> The UE checks if the reselected cell belongs to same RAN Notification area as the cell where the UE last received RRCRelease or entered RRC_INACTIVE state (RAN Notification area is signaled in system information transmitted by cell or RRC signaling). The UE may additionally check whether the reselected cell supports multicast reception in RRC_INACTIVE state.
> If the reselected cell belongs to same RAN Notification area as the cell where the UE last received RRCRelease or entered RRC_INACTIVE state and if the reselected cell supports multicast reception in RRC_INACTIVE state; or
> If the reselected cell belongs to same RAN Notification area as the cell where the UE last received RRCRelease or entered RRC_INACTIVE state:
>> For the multicast sessions which the UE is currently receiving and supported in reselected cell, the UE continues to receive multicast reception in RRC_INACTIVE state.
>> For the multicast sessions which the UE is currently receiving and not supported in reselected cell, the UE stops multicast reception in RRC_INACTIVE.
>> If the MRB(s) configuration for multicast reception in RRC_INACTIVE is different in reselected cell, the UE applies the configuration of the reselected cell (in system information or in RRCReconfiguration message and/or in RRCRelease message).
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicates PDCP suspend for all the established multicast MRB(s).
>> The UE may initiate RRC Resume procedure for entering RRC_CONNECTED state.

### Method 4

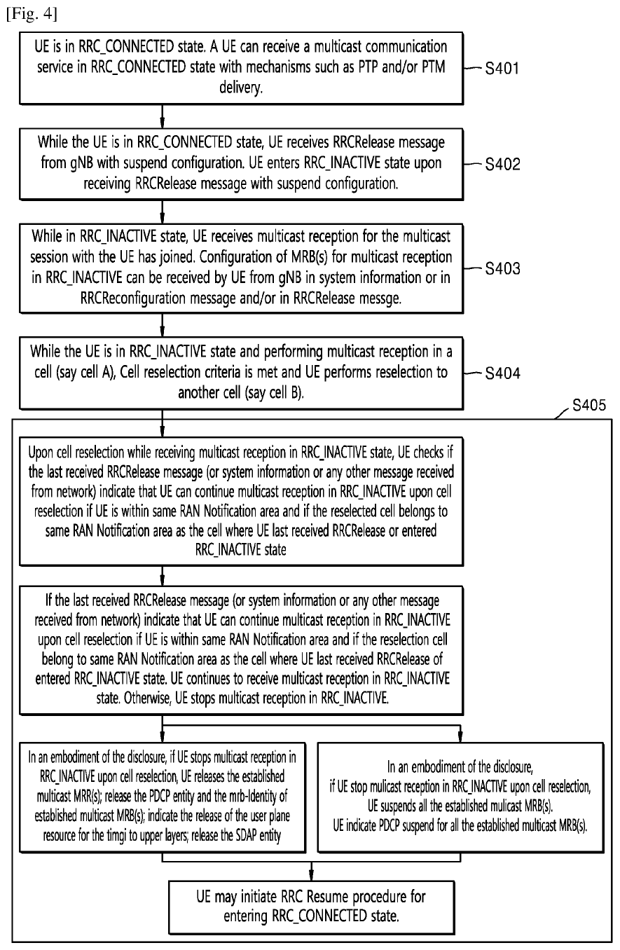

FIG. 4 illustrates a flow chart describing UE operation according to an embodiment of the disclosure.

In operation S401: A UE is in RRC_CONNECTED state. The UE can receive a multicast communication service in RRC_CONNECTED state with mechanisms such as PTP and/or PTM delivery. For a multicast session, the gNB provides multicast MRB configuration(s) to the UE via dedicated RRC signalling (e.g. RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities

In operation S402: While the UE is in RRC_CONNECTED state, the UE receives RRCRelease message from the gNB with suspend configuration. The UE enters RRC_INACTIVE state upon receiving RRCRelease message with suspend configuration.

In operation S403: While in RRC_INACTIVE state, the UE receives multicast reception for the multicast session which the UE has joined. If a multicast session is active at the time of entering RRC_INACTIVE state, the UE continues multicast reception of that multicast session; and the UE need not suspend the MRB (or MRB with PTM) corresponding to active multicast session at the time of entering RRC_INACTIVE state. If a multicast session is not active at the time of entering RRC_INACTIVE state, the UE suspends the MRB corresponding to the multicast session when entering RRC_INACTIVE state. The UE resumes the MRB(s) and starts multicast reception in RRC_INACTIVE when session activation notification in paging message is received by the UE for that multicast session(s) (i.e. TMGI(s) is included in paging message for multicast sessions activated). In an embodiment of this disclosure, if the UE receives paging message:
1> if in RRC_INACTIVE and the UE has joined one or more MBS session(s) indicated by the TMGI included in the pagingGroupList; and
2> if multicast reception is supported in RRC_INACTIVE state (or if the UE has configuration for multicast reception in RRC_INACTIVE and/or if gNB has indicated that it supports multicast reception in RRC_INACTIVE in system information or RRC signalling (RRC Release or RRCReconfiguration):
3> the UE initiate procedure to receive multicast reception in RRC_INACTIVE (e.g. resume one or more MRB(s), establish/re-establish PDCP/RLC entity for the resumed MRBs, etc.)
2> else if none of the ue-Identity included in any of the PagingRecord, if included in the Paging message, matches the UE identity allocated by upper layers:
3> initiate the RRC connection resumption procedure with resumeCause set as below:
4> if the UE is configured by upper layers with Access Identity 1:
5> resumeCause is set to mps-PriorityAccess;
4> else if the UE is configured by upper layers with Access Identity 2:
5> resumeCause is set to mcs-PriorityAccess;
4> else if the UE is configured by upper layers with one or more Access Identities equal to 11-15:
5>resumeCause is set to highPriorityAccess;
4> else:
5> resumeCause is set to mt-Access.

Configuration of MRB(s) for multicast reception in RRC_INACTIVE can be received by the UE from gNB in system information or in RRCReconfiguration message and/or in RRCRelease message.

In operation S404: While the UE is in RRC_INACTIVE state and performing multicast reception in a cell (say cell A), Cell reselection criteria is met and the UE performs reselection to another cell (say cell B).

In operation S405: Upon cell reselection while receiving multicast reception in RRC_INACTIVE state, the UE performs the following operation:
> The UE checks if the last received RRCRelease message (or system information or any other message received from network) indicate that the UE can continue multicast reception in RRC_INACTIVE upon cell reselection if the UE is within same RAN Notification area and if the reselected cell belongs to same RAN Notification area as the cell where the UE last received RRCRelease or entered RRC_INACTIVE state (RAN Notification area is signaled in system information transmitted by cell or RRC signaling). The UE may additionally check whether the reselected cell supports multicast reception in RRC_INACTIVE state.
> If the last received RRCRelease message (or system information or any other message received from network) indicate that the UE can continue multicast reception in RRC_INACTIVE upon cell reselection if within same RAN Notification area and the reselected cell belongs to same RAN Notification area as the cell where the UE last received RRCRelease or entered RRC_INACTIVE state and if the reselected cell supports multicast reception in RRC_INACTIVE state;
or
> If the last received RRCRelease message (or system information or any other message received from network) indicate that the UE can continue multicast reception in RRC_INACTIVE upon cell reselection if within same RAN area and the reselected cell belongs to same RAN Notification area as the cell where the UE last received RRCRelease or entered RRC_INACTIVE state:
>> The UE continues to receive multicast reception in RRC_INACTIVE state. If the MRB(s) configuration for multicast reception in RRC_INACTIVE is different in reselected cell, the UE applies the configuration of the reselected cell (in system information or in RRCReconfiguration message and/or in RRCRelease message).
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicate PDCP suspend for all the established multicast MRB(s).
>> The UE may initiate RRC Resume procedure for entering RRC_CONNECTED state.

In operation S405 (Alternate): Upon cell reselection while receiving multicast reception in RRC_INACTIVE state, the UE performs the following operation:
> The UE checks if the last received RRCRelease message (or system information or any other message received from network) indicate that the UE can continue multicast reception in RRC_INACTIVE upon cell reselection if within same RAN Notification area and if the reselected cell belongs to same RAN Notification area as the cell where the UE last received RRCRelease or entered RRC_INACTIVE state (RAN Notification area is signaled in system information transmitted by cell or RRC signaling). The UE may additionally check whether the reselected cell supports multicast reception in RRC_INACTIVE state.
> If the last received RRCRelease message (or system information or any other message received from network) indicate that the UE can continue multicast reception in RRC_INACTIVE upon cell reselection if within same RAN Notification area and the reselected cell belongs to same RAN Notification area as the cell where the UE last received RRCRelease or entered RRC_INACTIVE state and if the reselected cell supports multicast reception in RRC_INACTIVE state;
or
> If the last received RRCRelease message (or system information or any other message received from network) indicate that the UE can continue multicast reception in RRC_INACTIVE upon cell reselection if within same RAN Notification area and the reselected cell belongs to same RAN Notification area as the cell where the UE last received RRCRelease or entered RRC_INACTIVE state:
>> For the multicast sessions which the UE is currently receiving and supported in reselected cell, the UE continues to receive multicast reception in RRC_INACTIVE state.
>> For the multicast sessions which the UE is currently receiving and not supported in reselected cell, the UE stops multicast reception in RRC_INACTIVE.
>> If the MRB(s) configuration for multicast reception in RRC_INACTIVE is different in reselected cell, the UE applies the configuration of the reselected cell (in system information or in RRCReconfiguration message and/or in RRCRelease message).
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicate PDCP suspend for all the established multicast MRB(s).
>> The UE may initiate RRC Resume procedure for entering RRC_CONNECTED state.

### Method 5

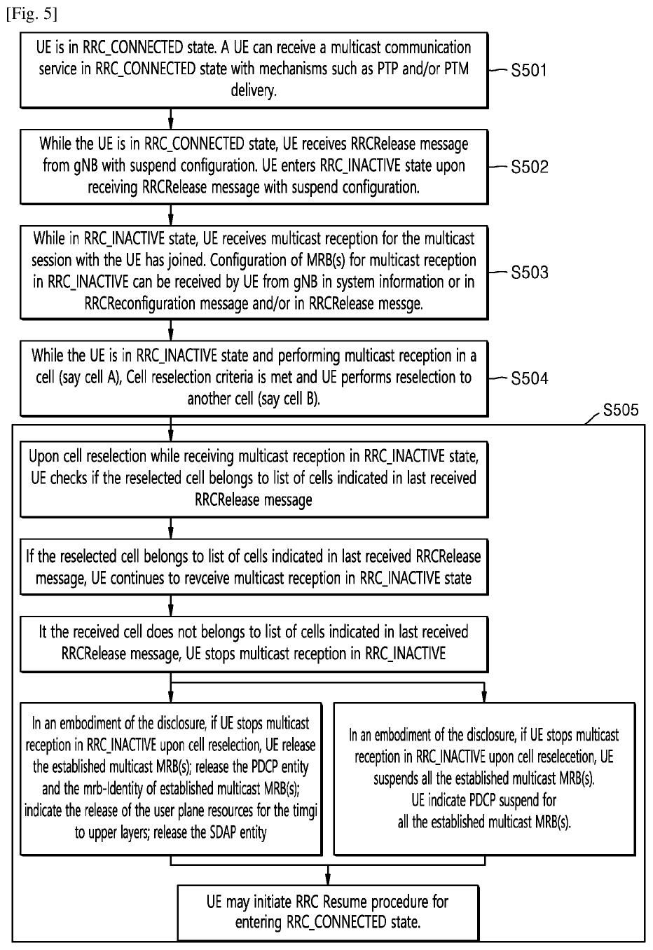

FIG. 5 illustrates a flow chart describing UE operation according to an embodiment of the disclosure.

In operation S501: A UE is in RRC_CONNECTED state. The UE can receive a multicast communication service in RRC_CONNECTED state with mechanisms such as PTP and/or PTM delivery. For a multicast session, the gNB provides multicast MRB configuration(s) to the UE via dedicated RRC signalling (e.g. RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

In operation S502: While the UE is in RRC_CONNECTED state, the UE receives RRCRelease message from gNB with suspend configuration. The UE enters RRC_INACTIVE state upon receiving RRCRelease message with suspend configuration. RRCRelease may include list of cells where the UE can receive multicast reception in RRC_INACTIVE state using the configuration received from PCell or from any cell belonging to this list.

In operation S503: While in RRC_INACTIVE state, the UE receives multicast reception for the multicast session which the UE has joined. If a multicast session is active at the time of entering RRC_INACTIVE state, the UE continues multicast reception of that multicast session; and the UE need not suspend the MRB (or MRB with PTM) corresponding to active multicast session at the time of entering RRC_INACTIVE state. If a multicast session is not active at the time of entering RRC_INACTIVE state, the UE suspends the MRB corresponding to the multicast session when entering RRC_INACTIVE state. The UE resumes the MRB(s) and starts multicast reception in RRC_INACTIVE when session activation notification in paging message is received by the UE for that multicast session(s) (i.e. TMGI(s) is included in paging message for multicast sessions activated). In an embodiment of this disclosure, if the UE receives paging message:
1> if in RRC_INACTIVE and the UE has joined one or more MBS session(s) indicated by the TMGI included in the pagingGroupList; and
2> if multicast reception is supported in RRC_INACTIVE state (or if the UE has configuration for multicast reception in RRC_INACTIVE and/or if gNB has indicated that it supports multicast reception in RRC_INACTIVE in system information or RRC signalling (RRC Release or RRCReconfiguration):
3> the UE initiate procedure to receive multicast reception in RRC_INACTIVE (e.g. resume one or more MRB(s), establish/re-establish PDCP/RLC entity for the resumed MRBs, etc.)
2> else if none of the ue-Identity included in any of the PagingRecord, if included in the Paging message, matches the UE identity allocated by upper layers:
3> initiate the RRC connection resumption procedure with resumeCause set as below:
4> if the UE is configured by upper layers with Access Identity 1:
5> resumeCause is set to mps-PriorityAccess;
4> else if the UE is configured by upper layers with Access Identity 2:
5> resumeCause is set to mcs-PriorityAccess;
4> else if the UE is configured by upper layers with one or more Access Identities equal to 11-15:
5> resumeCause is set to highPriorityAccess;
4> else:
5> resumeCause is set to mt-Access.

Configuration of MRB(s) for multicast reception in RRC_INACTIVE can be received by the UE from gNB in system information or in RRCReconfiguration message and/or in RRCRelease message.

In operation S504: While the UE is in RRC_INACTIVE state and performing multicast reception in a cell (say cell A), Cell reselection criteria is met and the UE performs reselection to another cell (say cell B).

In operation S505: Upon cell reselection while receiving multicast reception in RRC_INACTIVE state, the UE performs the following operation:
> The UE checks if the reselected cell belongs to list of cells indicated in last received RRCRelease message. The UE may additionally check whether the reselected cell supports multicast reception in RRC_INACTIVE state.
> If the reselected cell belongs to list of cells indicated in last received RRCRelease message and if the reselected cell supports multicast reception in RRC_INACTIVE state; or
> If the reselected cell belongs to list of cells indicated in last received RRCRelease message:

>> The UE continues to receive multicast reception in RRC_INACTIVE state. If the MRB(s) configuration for multicast reception in RRC_INACTIVE is different in reselected cell, the UE applies the configuration of the reselected cell (in system information or in RRCReconfiguration message and/or in RRCRelease message).
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicate PDCP suspend for all the established multicast MRB(s).
>> The UE may initiate RRC Resume procedure for entering RRC_CONNECTED state.

In operation S505 (Alternate): Upon cell reselection while receiving multicast reception in RRC_INACTIVE state, the UE performs the following operation:
> The UE checks if the reselected cell belongs to list of cells indicated in last received RRCRelease message. the UE may additionally check whether the reselected cell supports multicast reception in RRC_INACTIVE state.
> If the reselected cell belongs to list of cells indicated in last received RRCRelease message and if the reselected cell supports multicast reception in RRC_INACTIVE state; or
> If the reselected cell belongs to list of cells indicated in last received RRCRelease message:
>> For the multicast sessions which the UE is currently receiving and supported in reselected cell, the UE continues to receive multicast reception in RRC_INACTIVE state.
>> For the multicast sessions which the UE is currently receiving and not supported in reselected cell, the UE stops multicast reception in RRC_INACTIVE.
>> If the MRB(s) configuration for multicast reception in RRC_INACTIVE is different in reselected cell, the UE applies the configuration of the reselected cell (in system information or in RRCReconfiguration message and/or in RRCRelease message).
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicates PDCP suspend for all the established multicast MRB(s).
>> The UE may initiate RRC Resume procedure for entering RRC_CONNECTED state.

### Method 6

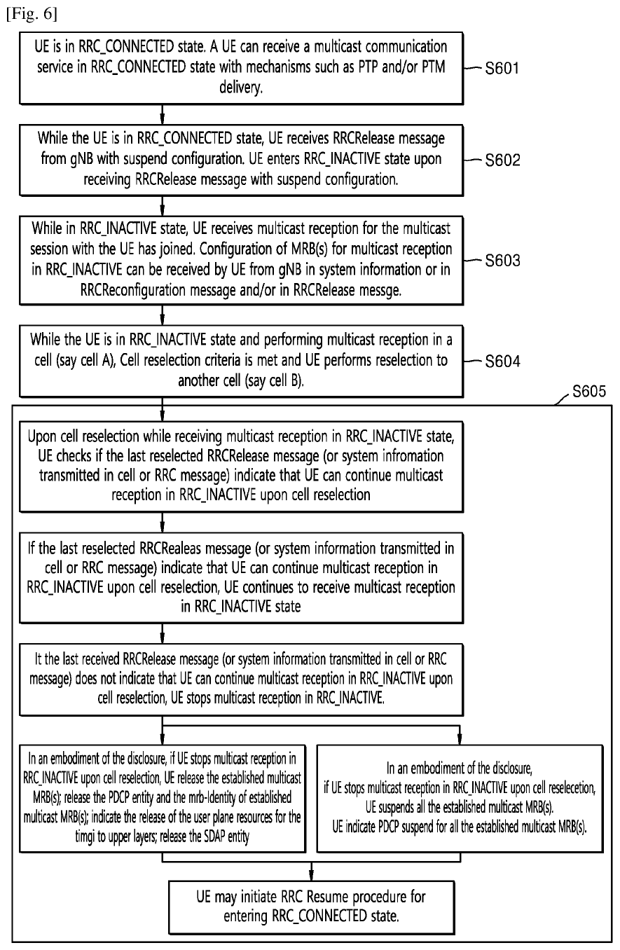

FIG. 6 illustrates a flow chart describing UE operation according to an embodiment of the disclosure.

In operation S601: A UE is in RRC_CONNECTED state. The UE can receive a multicast communication service in RRC_CONNECTED state with mechanisms such as PTP and/or PTM delivery. For a multicast session, gNB provides multicast MRB configuration(s) to the UE via dedicated RRC signalling (e.g. RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

In operation S602: While the UE is in RRC_CONNECTED state, the UE receives RRCRelease message from the gNB with suspend configuration. The UE enters RRC_INACTIVE state upon receiving RRCRelease message with suspend configuration. RRCRelease message may indicate whether the UE can continue multicast reception in RRC_INACTIVE upon cell reselection.

In operation S603: While in RRC_INACTIVE state, the UE receives multicast reception for the multicast session which the UE has joined. If a multicast session is active at the time of entering RRC_INACTIVE state, the UE continues multicast reception of that multicast session; and the UE need not suspend the MRB (or MRB with PTM) corresponding to active multicast session at the time of entering RRC_INACTIVE state. If a multicast session is not active at the time of entering RRC_INACTIVE state, the UE suspends the MRB corresponding to the multicast session when entering RRC_INACTIVE state. The UE resumes the MRB(s) and starts multicast reception in RRC_INACTIVE when session activation notification in paging message is received by the UE for that multicast session(s) (i.e. TMGI(s) is included in paging message for multicast sessions activated). In an embodiment of this disclosure, if the UE receives paging message:
1> if in RRC_INACTIVE and the UE has joined one or more MBS session(s) indicated by the TMGI included in the pagingGroupList; and
2> if multicast reception is supported in RRC_INACTIVE state (or if the UE has configuration for multicast reception in RRC_INACTIVE and/or if gNB has indicated that it supports multicast reception in RRC_INACTIVE in system information or RRC signalling (RRC Release or RRCReconfiguration):
3> UE initiate procedure to receive multicast reception in RRC_INACTIVE (e.g. resume one or more MRB(s), establish/re-establish PDCP/RLC entity for the resumed MRBs, etc.)
2> else if none of the ue-Identity included in any of the PagingRecord, if included in the Paging message, matches the UE identity allocated by upper layers:
3> initiate the RRC connection resumption procedure with resumeCause set as below:
4> if the UE is configured by upper layers with Access Identity 1:
5> resumeCause is set to mps-PriorityAccess;
4> else if the UE is configured by upper layers with Access Identity 2:
5> resumeCause is set to mcs-PriorityAccess;
4> else if the UE is configured by upper layers with one or more Access Identities equal to 11-15:
5> resumeCause is set to highPriorityAccess;
4> else:
5> resumeCause is set to mt-Access.

Configuration of MRB(s) for multicast reception in RRC_INACTIVE can be received by the UE from the gNB in system information or in RRCReconfiguration message and/or in RRCRelease message.

In operation S604: While the UE is in RRC_INACTIVE state and performing multicast reception in a cell (say cell A), Cell reselection criteria is met and the UE performs reselection to another cell (say cell B).

In operation S605: Upon cell reselection while receiving multicast reception in RRC_INACTIVE state, the UE performs the following operation:
> The UE checks if the last received RRCRelease message (or system information transmitted in cell or RRC message) indicates that the UE can continue multicast reception in RRC_INACTIVE upon cell reselection. The UE may additionally check whether the reselected cell supports multicast reception in RRC_INACTIVE state.
> If the last received RRCRelease (or system information transmitted in cell or RRC message) indicates that the UE can continue multicast reception in RRC_INACTIVE upon cell reselection and if the reselected cell supports multicast reception in RRC_INACTIVE state; or
> If the last received RRCRelease (or system information transmitted in cell or RRC message) indicates that the UE can continue multicast reception in RRC_INACTIVE upon cell reselection:
>> The UE continues to receive multicast reception in RRC_INACTIVE state. If the MRB(s) configuration for multicast reception in RRC_INACTIVE is different in reselected cell, the UE applies the configuration of the reselected cell (in system information or in RRCReconfiguration message and/or in RRCRelease message).
> Else:
>> UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicates PDCP suspend for all the established multicast MRB(s).
>> The UE may initiate RRC Resume procedure for entering RRC_CONNECTED state.

In operation S605 (Alternate): Upon cell reselection while receiving multicast reception in RRC_INACTIVE state, the UE performs the following operation:
> The UE checks if the last received RRCRelease message (or system information transmitted in cell or RRC message) indicate that the UE can continue multicast reception in RRC_INACTIVE upon cell reselection. The UE may additionally check whether the reselected cell supports multicast reception in RRC_INACTIVE state.
> If the last received RRCRelease (or system information transmitted in cell or RRC message) indicate that the UE can continue multicast reception in RRC_INACTIVE upon cell reselection and if the reselected cell supports multicast reception in RRC_INACTIVE state; or
> If the last received RRCRelease (or system information transmitted in cell or RRC message) indicate that the UE can continue multicast reception in RRC_INACTIVE upon cell reselection:
>> For the multicast sessions which the UE is currently receiving and supported in reselected cell, the UE continues to receive multicast reception in RRC_INACTIVE state.
>> For the multicast sessions which the UE is currently receiving and not supported in reselected cell, the UE stops multicast reception in RRC_INACTIVE.
>> If the MRB(s) configuration for multicast reception in RRC_INACTIVE is different in reselected cell, the UE applies the configuration of the reselected cell (in system information or in RRCReconfiguration message and/or in RRCRelease message).
> Else:
>> UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicates PDCP suspend for all the established multicast MRB(s).
>> The UE may initiate RRC Resume procedure for entering RRC_CONNECTED state.

### Method 7

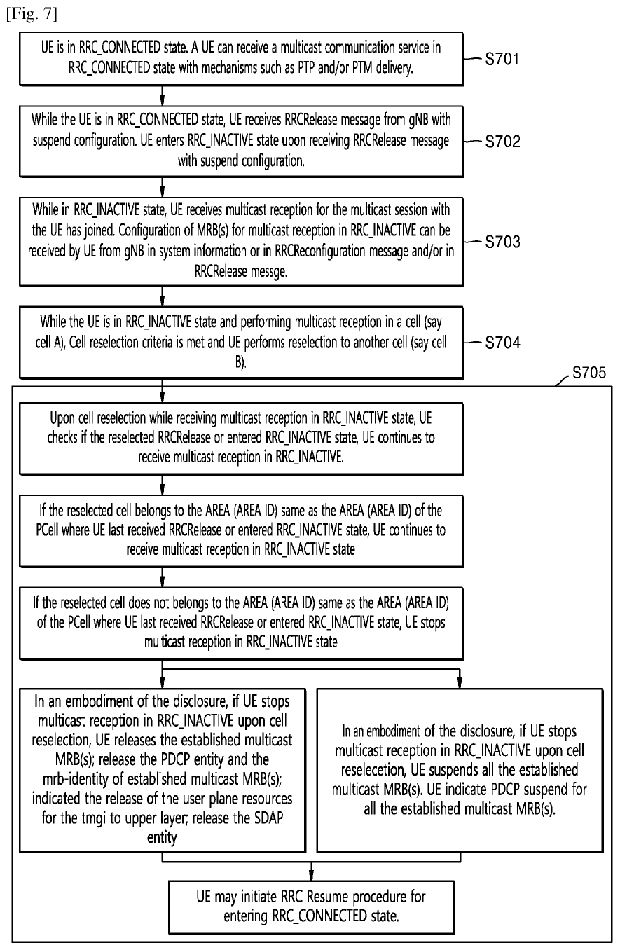

FIG. 7 illustrates a flow chart describing UE operation according to an embodiment of the disclosure.

In operation S701: A UE is in RRC_CONNECTED state. The UE can receive a multicast communication service in RRC_CONNECTED state with mechanisms such as PTP and/or PTM delivery. For a multicast session, the gNB provides multicast MRB configuration(s) to the UE via dedicated RRC signalling (e.g. RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

In operation S702: While the UE is in RRC_CONNECTED state, the UE receives RRCRelease message from the gNB with suspend configuration. The UE enters RRC_INACTIVE state upon receiving RRCRelease message with suspend configuration. RRCRelease message may indicate whether the UE can continue multicast reception in RRC_INACTIVE upon cell reselection.

In operation S703: While in RRC_INACTIVE state, the UE receives multicast reception for the multicast session which the UE has joined. If a multicast session is active at the time of entering RRC_INACTIVE state, the UE continues multicast reception of that multicast session; and the UE need not suspend the MRB (or MRB with PTM) corresponding to active multicast session at the time of entering RRC_INACTIVE state. If a multicast session is not active at the time of entering RRC_INACTIVE state, the UE suspends the MRB corresponding to the multicast session when entering RRC_INACTIVE state. The UE resumes the MRB(s) and starts multicast reception in RRC_INACTIVE when session activation notification in paging message is received by the UE for that multicast session(s) (i.e. TMGI(s) is included in paging message for multicast sessions activated). In an embodiment of this disclosure, if the UE receives paging message:
1> if in RRC_INACTIVE and the UE has joined one or more MBS session(s) indicated by the TMGI included in the pagingGroupList; and
2> if multicast reception is supported in RRC_INACTIVE state (or if the UE has configuration for multicast reception in RRC_INACTIVE and/or if gNB has indicated that it supports multicast reception in RRC_INACTIVE in system information or RRC signalling (RRC Release or RRCReconfiguration):
3> UE initiate procedure to receive multicast reception in RRC_INACTIVE (e.g. resume one or more MRB(s), establish/re-establish PDCP/RLC entity for the resumed MRBs, etc.)
2>2> else if none of the ue-Identity included in any of the PagingRecord, if included in the Paging message, matches the UE identity allocated by upper layers
:
3> initiate the RRC connection resumption procedure with resumeCause set as below:
4> if the UE is configured by upper layers with Access Identity 1:
5> resumeCause is set to mps-PriorityAccess;
4> else if the UE is configured by upper layers with Access Identity 2:
5> resumeCause is set to mcs-PriorityAccess;
4> else if the UE is configured by upper layers with one or more Access Identities equal to 11-15:
5> resumeCause is set to highPriorityAccess;
4> else:
4> resumeCause is set to mt-Access.

Configuration of MRB(s) for multicast reception in RRC_INACTIVE can be received by the UE from the gNB in system information or in RRCReconfiguration message and/or in RRCRelease message.

In operation S704: While the UE is in RRC_INACTIVE state and performing multicast reception in a cell (say cell A), Cell reselection criteria is met and the UE performs reselection to another cell (say cell B).

In operation S705: Upon cell reselection while receiving multicast reception in RRC_INACTIVE state, the UE performs the following operation:
> The UE checks if the reselected cell belongs to the AREA (AREA ID) same as the AREA (AREA ID) of the PCell where the UE last received RRCRelease or entered RRC_INACTIVE state. The UE may additionally check whether the reselected cell supports multicast reception in RRC_INACTIVE state. AREA ID of cell can be transmitted/received by gNB/UE in system information. AREA IDs of cells can be transmitted/received by gNB/UE in RRC message or NAS message. In an embodiment AREA ID can be tracking area ID or RAN notification area ID or system information area ID or a new ID.
> If the reselected cell belongs to the AREA (AREA ID) same as the AREA (AREA ID) of the PCell where the UE last received RRCRelease or entered RRC_INACTIVE state and if the reselected cell supports multicast reception in RRC_INACTIVE state; or
> If the reselected cell belongs to the AREA (AREA ID) same as the AREA (AREA ID) of the PCell where the UE last received RRCRelease or entered RRC_INACTIVE state:
>> The UE continues to receive multicast reception in RRC_INACTIVE state. If the MRB(s) configuration for multicast reception in RRC_INACTIVE is different in reselected cell, the UE applies the configuration of the reselected cell (in system information or in RRCReconfiguration message and/or in RRCRelease message).
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity.
>> In an embodiment of the disclosure, the UE suspends all the established multicast MRB(s). The UE indicate PDCP suspend for all the established multicast MRB(s).
>> The UE may initiate RRC Resume procedure for entering RRC_CONNECTED state.

In operation S705 (Alternate): Upon cell reselection while receiving multicast reception in RRC_INACTIVE state, the UE performs the following operation:
> The UE checks if the reselected cell belongs to the AREA (AREA ID) same as the AREA (AREA ID) of the PCell where UE last received RRCRelease or entered RRC_INACTIVE state. The UE may additionally check whether the reselected cell supports multicast reception in RRC_INACTIVE state. AREA ID of cell can be transmitted/received by the gNB/UE in system information. AREA IDs of cells can be transmitted/received by the gNB/UE in RRC message or NAS message. In an embodiment AREA ID can be tracking area ID or RAN notification area ID or system information area ID or a new ID.
> If the reselected cell belongs to the AREA (AREA ID) same as the AREA (AREA ID) of the PCell where the UE last received RRCRelease or entered RRC_INACTIVE state and if the reselected cell supports multicast reception in RRC_INACTIVE state; or
> If the reselected cell belongs to the AREA (AREA ID) same as the AREA (AREA ID) of the PCell where the UE last received RRCRelease or entered RRC_INACTIVE state:
>> For the multicast sessions which the UE is currently receiving and supported in reselected cell, the UE continues to receive multicast reception in RRC_INACTIVE state.
>> For the multicast sessions which the UE is currently receiving and not supported in reselected cell, the UE stops multicast reception in RRC_INACTIVE.
>> If the MRB(s) configuration for multicast reception in RRC_INACTIVE is different in reselected cell, the UE applies the configuration of the reselected cell (in system information or in RRCReconfiguration message and/or in RRCRelease message)
> Else:
>> The UE stops multicast reception in RRC_INACTIVE.
>> In an embodiment of the disclosure, the UE releases the established multicast MRB(s); releases the PDCP entity and the mrb-Identity of established multicast MRB(s); indicates the release of the user plane resources for the tmgi to upper layers; releases the SDAP entity
>> In an embodiment of the disclosure, the UE suspends all the established multicast MRB(s). The UE indicates PDCP suspend for all the established multicast MRB(s).
>> The UE may initiate RRC Resume procedure for entering RRC_CONNECTED state.

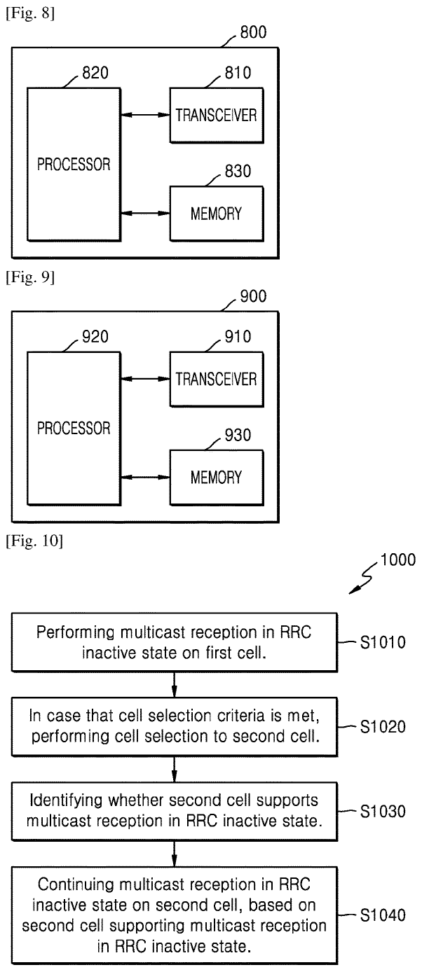

FIG. 8 illustrates a structure of a UE, according to an embodiment of the disclosure.

Referring to FIG. 8, the UE 800 may include a processor 820, a memory 830, and a transceiver 810. However, elements of the UE 800 are not limited thereto. For example, the UE 800 may include more or fewer elements than those described above. The processor 820, the memory 830, and the transceiver 810 may be implemented as a single chip.

The processor 820 may include one or more processors. In this case, the one or more processors may include a general-purpose processor such as a CPU, an AP, or a DSP, a graphics processor such as a GPU or a VPU, or an AI processor such as an NPU. For example, when the one or more processors are AI processors, they may be designed as a hardware structure specialized in processing a particular AI model.

The processor 820 may control a series of processes so that the UE 800 operates according to an embodiment. For example, the processor 820 may receive a control signal and a data signal through the transceiver 810 and process the received control signal and data signal. The processor 820 may transmit the processed control signal and data signal through the transceiver 810. Furthermore, the processor 820 may control input data derived from the received control signal and data signal to be processed according to a predefined operation rule or AI model stored in the memory 830. The processor 820 may write data to and read data from the memory 830, may perform functions of a protocol stack required by communication standards, and may include at least one processor. A part of the transceiver 810 or the processor 820 may be referred to as a CP.

The memory 830 may store a program and data required to operate the UE 800, may store control information or data included in a signal obtained by the UE 800, and may store control information or data included in a signal obtained by the UE800. The memory 830 may include a storage medium such as a ROM, a RAM, a hard disk, a CD-ROM, and a DVD, or a combination thereof. The memory 830 may not be separately provided but may be included in the processor 820. The memory 830 may include a volatile memory, a non-volatile memory, or a combination of a volatile memory and a non-volatile memory and may provide stored data according to a request of the processor 820.

The transceiver 810 may refer to a transmitter and a receiver, and the transceiver 810 of the UE 800 may transmit or receive signals to or from a BS or a network entity. The transmitted or received signals may include control information and data. To this end, the transceiver 810 may include an RF transmitter for up-converting and amplifying a frequency of a transmitted signal, and an RF receiver for low-noise amplifying and down-converting a frequency of a received signal. However, this is merely an example of the transceiver 810, and elements of the transceiver 810 are not limited to the RF transmitter and the RF receiver. The transceiver 810 may receive signals through wireless channels and output the signals to the processor 820, and may transmit signals output from the processor 820 through wireless channels.

The processor 820 may be configured to perform multicast reception in a radio resource control (RRC) inactive state, on a first cell; in case that cell selection criteria is met, selecting a second cell for the multicast reception; identify whether the selected second cell supports the multicast reception in the RRC inactive state; and perform continuously the multicast reception in the RRC inactive state on the selected second cell based on that the selected second cell supports the multicast reception in the RRC inactive state.

FIG. 9 illustrates a structure of a BS, according to an embodiment of the disclosure.

Referring to FIG. 9, the BS 900 may include a transceiver 910, a processor 920, and a memory 930, which may collectively operate according to a communication method of the BS 900. However, elements of the BS 900 are not limited thereto. For example, the BS 900 may include more or fewer elements than those described above. The transceiver 910, the processor 920, and the memory 930 may be implemented as a single chip and the processor 920 may include one or more processors.

A receiver and a transmitter of the BS 900 are collectively referred to as the transceiver 910, which may transmit or receive signals (i.e., control information and data) to or from a UE or a network entity. To this end, the transceiver 910 may include an RF transmitter for up-converting and amplifying a frequency of a transmitted signal, and an RF receiver for low-noise amplifying and down-converting a frequency of a received signal. However, this is merely an example of the transceiver 910, and elements of the transceiver 910 are not limited to the RF transmitter and the RF receiver.

The transceiver 910 may perform functions for transmitting and receiving signals via a wireless channel. For example, the transceiver 910 may receive signals through wireless channels and output the signals to the processor 920, and may transmit signals output from the processor 920 through wireless channels.

The memory 930 may store a program and data required to operate the BS 900 and may store control information or data included in a signal obtained by the BS. The memory 930 may include a storage medium such as a read-only memory (ROM), a random-access memory (RAM), a hard disk, a compact disc (CD)-ROM, or a digital versatile disc (DVD), or a combination thereof. The memory 930 may not be separately provided but may be included in the processor 920. The memory 930 may include a volatile memory, a non-volatile memory, or a combination of a volatile memory and a non-volatile memory, and may provide stored data according to a request of the processor 920.

The processor 920 may control a series of processes so that the BS 900 operates according to an embodiment. For example, the processor 920 may receive a control signal and a data signal through the transceiver 910 and process the received control signal and data signal. The processor 920 may transmit the processed control signal and data signal through the transceiver 910, may write data to and read data from the memory 930, and may perform functions of a protocol stack required by communication standards. To this end, the processor 920 may include at least one processor or microprocessor. A part of the transceiver 910 or the processor 920 may be referred to as a communication processor (CP).

The processor 920 may include one or more processors such as a central processing unit (CPU), an application processor (AP), a digital signal processor (DSP), a graphics processor such as a graphics processing unit (GPU) or a vision processing unit (VPU), or an AI processor such as a neural processing unit (NPU). For example, when the one or more processors are AI processors, they may be designed as a hardware structure specialized in processing a particular AI model.

FIG. 10 illustrates a flowchart of method performed by UE, according to an embodiment of the disclosure.

In operation S1010, the method 1000 include performing multicast reception in a radio resource control (RRC) inactive state on a first cell.

In operation S1020, the method 1000 include, in case that cell selection criteria is met, performing cell selection to a second cell.

In operation S1030, the method 1000 include identifying whether the second cell supports the multicast reception in the RRC inactive state.

In operation S1040, the method 1000 include continuing the multicast reception in the RRC inactive state on the second cell, based on the second cell supporting the multicast reception in the RRC inactive state.

The method 1000 may include receiving, on the second cell, system information including information indicating whether the second cell supports the multicast reception in RRC inactive state.

The method 1000 may include, in case that multicast/broadcast service radio bearer (MRB) configuration for the multicast reception in the RRC inactive state on the second cell is different from MRB configuration for the multicast reception in the RRC inactive state on the first cell, continuing the multicast reception in the RRC inactive state based on the MRB configuration on the second cell.

The method 1000 may include, in case that the second cell supports the multicast reception in the RRC inactive state, continuing the multicast reception in the RRC inactive state for a multicast session which is supported in the second cell.

The method 1000 may include, in case that the second cell supports the multicast reception in the RRC inactive state, stopping the multicast reception in the RRC inactive state for a multicast session which is not supported in the second cell.

The method 1000 may include, in case that the second cell does not support the multicast reception in the RRC inactive state, stopping the multicast reception in the RRC inactive state.

The method 1000 may include, in case that the second cell does not support the multicast reception in the RRC inactive state, releasing one or more established multicast/broadcast service radio bearers (MRBs).

The method 1000 may include, in case that the second cell does not support the multicast reception in the RRC inactive state, suspending one or more established multicast/broadcast service radio bearers (MRBs).

According to an aspect of the disclosure, a method performed by a user equipment (UE) in wireless communication system is provided. The method may include performing multicast reception in a radio resource control (RRC) inactive state on a first cell. The method may include, in case that cell selection criteria is met, performing cell selection to a second cell. The method may include identifying whether the second cell supports the multicast reception in the RRC inactive state. The method may include continuing the multicast reception in the RRC inactive state on the second cell, based on the second cell supporting the multicast reception in the RRC inactive state.

According to an embodiment, the method may include receiving, on the second cell, system information including information indicating whether the second cell supports the multicast reception in RRC inactive state.

According to an embodiment, the method may include, in case that multicast/ broadcast service radio bearer (MRB) configuration for the multicast reception in the RRC inactive state on the second cell is different from MRB configuration for the multicast reception in the RRC inactive state on the first cell, continuing the multicast reception in the RRC inactive state based on the MRB configuration on the second cell.

According to an embodiment, the method may include, in case that the second cell supports the multicast reception in the RRC inactive state, continuing the multicast reception in the RRC inactive state for a multicast session which is supported in the second cell.

According to an embodiment, the method may include, in case that the second cell supports the multicast reception in the RRC inactive state, stopping the multicast reception in the RRC inactive state for a multicast session which is not supported in the second cell.

According to an embodiment, the method may include, in case that the second cell does not support the multicast reception in the RRC inactive state, stopping the multicast reception in the RRC inactive state.

According to an embodiment, the method may include, in case that the second cell does not support the multicast reception in the RRC inactive state, releasing one or more established multicast/broadcast service radio bearers (MRBs).

According to an embodiment, the method may include, in case that the second cell does not support the multicast reception in the RRC inactive state, suspending one or more established multicast/broadcast service radio bearers (MRBs).

According to an aspect of the disclosure, a User Equipment (UE) comprising a transceiver and at least one processor is provided. The at least one processor may be configured to perform multicast reception in a radio resource control (RRC) inactive state on a first cell. The at least one processor may be configured to perform cell selection to a second cell in case that cell selection criteria is met. The at least one processor may be configured to identify whether the second cell supports the multicast reception in the RRC inactive state. The at least one processor may be configured to continue the multicast reception in the RRC inactive state on the second cell, based on the second cell supporting the multicast reception in the RRC inactive state.

According to an embodiment, the at least one processor may be configured to continue the multicast reception in the RRC inactive state based on the MRB configuration on the second cell, in case that multicast/broadcast service radio bearer (MRB) configuration for the multicast reception in the RRC inactive state on the second cell is different from MRB configuration for the multicast reception in the RRC inactive state on the first cell.

According to an embodiment, the at least one processor may be configured to continue the multicast reception in the RRC inactive state for a multicast session which is supported in the second cell, in case that the second cell supports the multicast reception in the RRC inactive state.

According to an embodiment, the at least one processor may be configured to stop the multicast reception in the RRC inactive state for a multicast session which is not supported in the second cell, in case that the selected second cell supports the multicast reception in the RRC inactive state.

According to an embodiment, the at least one processor may be configured to stop the multicast reception in the RRC inactive state, in case that the second cell does not support the multicast reception in the RRC inactive state.

According to an embodiment, the at least one processor may be configured to release one or more established multicast/broadcast service radio bearers (MRBs) in case that the second cell does not support the multicast reception in the RRC inactive state.

According to an embodiment, the at least one processor may be configured to suspend one or more established MRBs in case that the selected second cell does not support the multicast reception in the RRC inactive state.

According to an embodiment, the at least one processor may be configured to receive, on the selected second cell, system information including information indicating whether the selected second cell supports the multicast reception in RRC inactive state.

In an embodiment of this disclosure gNB may indicate in RRC signaling (e.g. RRCRelease) message a method (amongst the methods 1 to 7 or amongst the subset of methods 1 to 7) is applied by UE upon cell reselection while receiving multicast reception in RRC_INACTIVE.

In an embodiment of this disclosure, UE may priorities cell reselection to cell supporting multicast reception in RRC_INACTIVE amongst the suitable cells available (or cells which meet reselection criteria as specified in TS 38.304) on a carrier frequency. In an embodiment of the disclosure, UE may priorities cell reselection to a carrier frequency supporting multicast reception in RRC_INACTIVE amongst the carrier frequencies for which suitable cells (or cells which meet reselection criteria as specified in TS 38.304) are available. In an embodiment of the disclosure, UE may priorities cell reselection to cell supporting multicast reception in RRC_INACTIVE for the multicast sessions in which UE is interested amongst the suitable cells available (or cells which meet reselection criteria as specified in TS 38.304) on a carrier frequency. In an embodiment of the disclosure, UE may priorities cell reselection to a carrier frequency supporting multicast reception in RRC_INACTIVE for the multicast sessions in which UE is interested amongst the carrier frequencies for which suitable cells are available (or cells which meet reselection criteria as specified in TS 38.304).

It should be understood that embodiments described herein should be considered in a descriptive sense only and not for purposes of limitation. Descriptions of features or aspects within each embodiment should be considered as available for other similar features or aspects in other embodiments. The afore-described embodiments may operate in combination when required. For example, a base station and a UE may operate according to a combination of parts of the embodiments.

1. A method performed by a user equipment (UE) in a wireless communication system, the method comprising:
performing multicast reception in a radio resource control (RRC) inactive state on a first cell;
in case that cell selection criteria is met, performing cell selection to a second cell;
identifying whether the second cell supports the multicast reception in the RRC inactive state; and
continuing the multicast reception in the RRC inactive state on the second cell, based on the second cell supporting the multicast reception in the RRC inactive state.

2. The method of claim 1, further comprising:
receiving, on the second cell, system information including information indicating whether the second cell supports the multicast reception in RRC inactive state.

3. The method of claim 1, wherein the continuing of the multicast reception in the RRC inactive state on the second cell comprises:
in case that multicast/broadcast service radio bearer (MRB) configuration for the multicast reception in the RRC inactive state on the second cell is different from MRB configuration for the multicast reception in the RRC inactive state on the first cell, continuing the multicast reception in the RRC inactive state based on the MRB configuration on the second cell.

4. The method of claim 1, wherein the continuing of the multicast reception in the RRC inactive state on the second cell comprises:
in case that the second cell supports the multicast reception in the RRC inactive state, continuing the multicast reception in the RRC inactive state for a multicast session which is supported in the second cell.

5. The method of claim 1, further comprising:
in case that the second cell supports the multicast reception in the RRC inactive state, stopping the multicast reception in the RRC inactive state for a multicast session which is not supported in the second cell.

6. The method of claim 1, further comprising:
in case that the second cell does not support the multicast reception in the RRC inactive state, stopping the multicast reception in the RRC inactive state.

7. The method of claim 1, further comprising:
in case that the second cell does not support the multicast reception in the RRC inactive state, releasing one or more established multicast/broadcast service radio bearers (MRBs).

8. The method of claim 1, further comprising:
in case that the second cell does not support the multicast reception in the RRC inactive state, suspending one or more established multicast/broadcast service radio bearers (MRBs).

9. A User Equipment (UE), comprising:
a transceiver; and
at least one processor coupled with the transceiver and configured to:
perform multicast reception in a radio resource control (RRC) inactive state on a first cell;
in case that cell selection criteria is met, perform cell selection to a second cell;
identify whether the second cell supports the multicast reception in the RRC inactive state; and
continue the multicast reception in the RRC inactive state on the second cell, based on the second cell supporting the multicast reception in the RRC inactive state.

10. The UE of claim 9, wherein at least one processor is configured to:
in case that multicast/broadcast service radio bearer (MRB) configuration for the multicast reception in the RRC inactive state on the second cell is different from MRB configuration for the multicast reception in the RRC inactive state on the first cell, continue the multicast reception in the RRC inactive state based on the MRB configuration on the second cell.

11. The UE of claim 9, wherein at least one processor is configured to:
in case that the second cell supports the multicast reception in the RRC inactive state, continue the multicast reception in the RRC inactive state for a multicast session which is supported in the second cell.

12. The UE of claim 9, wherein at least one processor is further configured to:
in case that the second cell supports the multicast reception in the RRC inactive state, stop the multicast reception in the RRC inactive state for a multicast session which is not supported in the second cell.

13. The UE of claim 9, wherein at least one processor is further configured to:
in case that the second cell does not support the multicast reception in the RRC inactive state, stop the multicast reception in the RRC inactive state.

14. The UE of claim 9, wherein at least one processor is further configured to:
in case that the second cell does not support the multicast reception in the RRC inactive state, release one or more established multicast/broadcast service radio bearers (MRBs).

15. The UE of claim 9, wherein at least one processor is further configured to:
in case that the second cell does not support the multicast reception in the RRC inactive state, suspend one or more established multicast/broadcast service radio bearers (MRBs).
